(19) United States
(12) Patent Application Publication
(10) Pub. No.: US 2026/0111449 A1
(43) Pub. Date: Apr. 23, 2026

(54) SYSTEM AND METHOD FOR MULTI-USER STORAGE AND RETRIEVAL OF DATABASED CHEMICAL KINETICS

(71) Applicants: Siddhant Meenor LAMBOR, Newark, DE (US); Sashank KASIRAJU, Bear, DE (US); Dionisios G. VLACHOS, Newark, DE (US)

(72) Inventors: Siddhant Meenor LAMBOR, Newark, DE (US); Sashank KASIRAJU, Bear, DE (US); Dionisios G. VLACHOS, Newark, DE (US)

(73) Assignee: University of Delaware, Newark, DE (US)

(21) Appl. No.: 19/118,732

(22) PCT Filed: Oct. 5, 2023
(86) PCT No.: PCT/US2023/034529

§ 371 Date: Apr. 4, 2025

Related U.S. Application Data
(60) Provisional application No. 63/413,446, filed on Oct. 5, 2022.

(51) Int. Cl. G06F 16/28

(52) U.S. Cl. CPC G06F 16/285

(57) ABSTRACT

A computing device configured to store one or more multiscale models of chemical kinetics, the computing device comprising a processor, a memory, and programming in the memory. Execution of the programming by the processor configures the computing device to implement functions. The computing device receives an input model of chemical kinetics. The computing device categorizes the input model with a scale category, and tests the input model based on a quality test. The computing device extracts metadata from the input model, and stores the input model based on the scale category and results of the quality test. The computing device receives a request for the one or more multiscale models of chemical kinetics, including one or more requested metadata. The computing device transmits the input model or a portion thereof in response to the request, based on a match between the one or more requested metadata and the extracted metadata.

### CROSS-REFERENCE TO RELATED APPLICATIONS

This application is a national phase application of International Application No. PCT/US2023/034529, filed Oct. 5, 2023, which claims the benefit of priority of U.S. provisional application No. 63/413,446, filed on Oct. 5, 2022, the entire contents of which are incorporated by reference herein for all purposes.

### STATEMENT ON FEDERALLY SPONSORED RESEARCH OR DEVELOPMENT

This invention was made with government support under the award number DE-EE0007888-9.5, awarded by the Department of Energy (DOE) Advanced Manufacturing Office (AMO). The government has certain rights in the invention.

### FIELD OF INVENTION

The invention relates to receiving, categorizing, testing, retrieving, and databasing multiscale models of chemical kinetics.

### BACKGROUND

A great advantage of computational research, in particular computational chemistry research, is the reproducibility and reusability of the computation research. Computational chemistry produces energies, structures, spectroscopic and kinetic properties of species and reactions, and more. Density functional theory (DFT) has been the predominant computational method, especially for heterogeneous catalysis. With the growth of open science, it is becoming increasingly common to attach modeling parameters and files, such as DFT data, to publications. Some publishers use or allow the use of third-party repositories to make data accessible. Still, these repositories do not cater to any data type or format and, therefore, cannot easily be queried based on chemical or catalyst properties. Although simulation files and the associated data are sometimes provided in the Supporting Information (SI) of the publications, the data format among the articles is inconsistent and potentially incomplete.

The past decade has experienced considerable growth in computational quantum chemistry databases driven by the materials genome initiative. The databases encompass a multitude of applications and quantities including energies, structures, bandgap, piezoelectric constants, elastic properties, polarization and magnetization properties, molecular dipole moments, and many more. There also have been undertakings that utilize DFT data for materials discovery with machine learning, force field development, and elevated data management, to name a few. Inorganic chemistry databases vary from a few thousand to millions of calculations.

Comparisons with experimental results remain the widely used standard to validate computationally generated data. The catalysis and broader scientific community consider peer-reviewed publication-associated data reliable. There has been a surge of research using machine learning tools, such as natural language processing, to extract specific data from journal articles. However, the lack of sufficient provenance and data quality in publications will hinder reproducibility and widespread use.

DFT calculations are often utilized in the multiscale modeling workflow and can be reused for several applications. DFT (input/output) files provide bond lengths, bond angles, electronic ground-state energies, electronic structure properties in the presence or absence of adsorbates, vibrational frequencies, and more. Prior DFT calculations, from publications or databases, can enable further analysis, such as Bader charge analysis, density of states, transition-state calculations, and applications across the multiscale modeling workflow. The use of DFT data in estimating thermochemistry and producing microkinetic models (MKMs) increases further the potential applications and the metadata generated, but the methods and assumptions invoked in these calculations are rarely thoroughly documented, creating reproducibility and retrieving challenges after students and postdoctoral researchers have left a group.

Databases that utilize high-throughput calculations to generate new data and predict materials are emerging. However, these data sets can lack for example transition-state energies that are needed for kinetics and software for querying reaction-based individual DFT calculations and complete reaction mechanisms. Other web applications provide reaction energies and corresponding structures of species in elementary reactions but do not provide sufficient original software files from DFT to reproduce results.

Accessibility and improvements in computational infrastructure and the success of MKMs in catalysis discovery have led to an enormous growth of MKM-related publications. However, an enormous amount of computational chemical research data directed to heterogeneous catalysis is still barricaded due to logistical limitations. Existing computational chemistry data-bases do not address the related data. There is a lack of a general database for multiscale modeling in heterogeneous catalysis. The impediments in accessing the unaltered original files of previously published data creates redundancy. This unnecessary redundancy adds to the ever-increasing demand and dependence on computational resources, high cost, and energy requirements.

### SUMMARY OF THE INVENTION

A software infrastructure spanning across the multiscale modeling workflow can enable accessing interlinked data across micro- and mesoscales to enable reaction mechanism generation, run kinetic analysis, and accelerate the adaptation of new materials at the macroscale. Sufficient provenance and characterization of data and computational environment, with uniform organization and easy accessibility, can allow the development of software tools for integration across the multiscale modeling workflow.

The Chemical Kinetics Database (CKineticsDB) systems, methods, and technologies describe a state-of-the-art datahub (e.g., data management framework, methodology, etc.) for DFT calculations, thermochemistry, multiscale modeling and related MKMs, and their associated data and metadata from the entire workflow, designed to be compliant with the FAIR guiding principles for scientific data management. The user-end application in the CKineticsDB systems is constructed in Python™ for data processing operations and with built-in features to extract data for common applications. The data are stored with the MongoDB™ Database Management System (DBMS) for extensibility and adaptation to varying data formats, with a referencing-based data model to reduce redundancy in storage—though other similar technologies such as the .NET Framework™ and Microsoft SQL Server™ can be used. The CKineticsDB systems and methods implement a referencing-based data model to store MKM files and the DFT calculations corresponding to those MKM files efficiently. The CKineticsDB systems and methods includes software that provides a graphical user interface (GUI) and a command-line user interface (CLI) to access the stored data based on software parameters, catalyst parameters, species and reactions of interest, and publications.

CKineticsDB technologies, which include CKineticsDB systems and methods, evaluate the incoming data for quality and uniformity, retain curated information from simulations, enables accurate regeneration of publication results, optimizes storage, and allows the selective retrieval of files based on domain-relevant catalyst, chemical kinetics, and simulation parameters. CKineticsDB technologies provides data from multiple scales of theory (ab initio calculations, thermochemistry, and microkinetic models) to accelerate the development of new reaction pathways, kinetic analysis of reaction mechanisms, and catalysis discovery, along with several data-driven applications. CKineticsDB technologies curate data to ensure diligence in calculation quality and uniform file organization, and comply with the FAIR (Findable, Accessible, Interoperable, and Reusable) guiding principles for scientific data management within the parameters imposed by the challenges faced by the community.

CKineticsDB technologies enable sensible data management in heterogeneous catalysis by providing modular software components to store and manage data locally, checking for quality of DFT calculations, perceiving and accessing data based on domain-relevant parameters, establishing data organization practices, and utilizing a software infrastructure for sharing and re-using of data in the community.

There are numerous potential applications of CKineticsDB technologies. Developing efficient catalysts, species, and reaction models to predict the thermochemistry and kinetics of surface reactions and subsequently the most probable reaction pathways requires reliable data at every level of the multiscale modeling workflow. Along with this data, CKineticsDB provides unaltered software files which researchers can use directly with the respective software to re-run simulations at user-defined parameters. This accelerates research at the macroscale with real-world implications by mitigating the efforts required at lower scales. In the multiscale MKM workflow, the computationally most expensive step is DFT. The inherent limitations of DFT often exacerbate efforts in developing and analyzing reaction mechanisms. There has been a strong interest in ML-based models to mitigate the time spent doing DFT calculations and probing and correcting the errors in DFT. CKineticsDB provides data (simulation files used to generate the results shown in published papers) associated with peer-reviewed publications in a curated and organized manner. This data can be used to build data-driven correlations across species and elementary reaction steps in a mechanism as well as traditional correlations such as the Bronsted-Evans-Polanyi or Bell-Evans-Polanyi (BEP), linear scaling relations, and transition-state vibrational scaling relationships.

CKineticsDB can greatly reduce the effort, time, and resources required to run DFT calculations and generate data for elementary reaction steps. For example, the hydrogenolyses of ethane and propane have overlapping reactions where the mechanisms of smaller molecules could be used to build the mechanisms of larger ones. The discovery of new catalysts and energy-efficient pathways for widely used industrial processes such as ethane oxidative dehydrogenation can be facilitated by the availability of data from reactions on multiple catalyst conformations. Access to such multiscale data can enable research into probing uncertainty quantification and error propagation from lower levels to higher levels of theory and assessing the impact on reaction modeling.

In accordance with an aspect of the present invention, A computing device or computer system is configured to store one or more multiscale models of chemical kinetics. The computing device comprises a processor, a memory; and programming in the memory. Execution of the programming by the processor configures the computing device to implement the following functions. The computing device receives an input model of chemical kinetics. The computing device categorizes the input model with one or more scale categories, or categorizes a portion of the input model with one or more scale categories. The computing device tests the input model based on a quality test. The computing device extracts metadata from the input model. The computing device stores the input model based on one or more scale categories and results of the quality test. The computing device receives a request for the one or more multiscale models of heterogenous catalysis, including one or more requested metadata. The computing device transmits the input model or a portion thereof in response to the request, based on a match between the one or more requested metadata and the extracted metadata.

### BRIEF DESCRIPTION OF THE DRAWINGS

FIG. 1 is an informational graphic depicting the general data set containing files from the DFT-MKM workflow.

FIG. 2 is a representation of top-level file organization according to the data organization policy.

FIG. 3 is a depiction of files conforming to the guidelines for organizing DFT sub-directories based on molecular species.

FIG. 4 is a depiction of files conforming to the guidelines for organizing specific DFT calculations and sub-directories for VASP™.

FIG. 5 is a depiction of files conforming to the guidelines for organizing specific DFT calculations and sub-directories for Gaussian™.

FIG. 6 is a depiction of files conforming to the guidelines for organizing MKM files.

FIG. 7 is a depiction of files conforming to the guidelines for organizing pMuTT files.

FIG. 8 is a schematic of features and advantages of MongoDB™ relevant to CKineticsDB.

FIG. 9 is a diagram of the computing infrastructure of the datahub as installed on a high-performance computing system.

FIG. 10 is a diagram of the CKineticsDB data and CKineticsDB software available for download at the user end.

FIG. 11 is a diagram of the modular design of the CKineticsDB application and database.

FIG. 12A is a depiction of the directory hierarchy for data to be tested for computational diligence

FIG. 12B is a depiction of the summary page of a data quality assessment document generated based on a data set.

FIG. 13 is a depiction of a quality assessment of one DFT calculation from a data set.

FIG. 14A is the pseudocode for identifying the missing files and generating the assessment file.

FIG. 14B is the pseudocode for assessing computational diligence in DFT calculations and generating the assessment file.

FIG. 15 is a diagram of a portion of the metadata extraction when uploading VASP™ DFT calculation data.

FIG. 16 is a schematic of a MongoDB™ database comprised of collections, with each collection containing several documents.

FIG. 17 is a visualization of DFT data shared between MKMs, showing that the shared DFT data does not need to be duplicated and embedded in each MKM.

FIG. 18 is an overview of the user-end downloading workflow.

FIG. 19 is a diagram of CKineticsDB implemented on a computing device.

### GLOSSARY

AMO . . . Advanced Manufacturing Office
ASE . . . Atomic Simulation Environment
BEP . . . Bronsted-Evans-Polanyi or Bell-Evans-Polanyi
BSON . . . Binary JSON
Chemkin™ . . . Software for modeling complex, chemically reacting systems
CHG . . . File containing information about lattice vectors, atomic coordinates and total charge density used in VASP™ calculations
CHGCAR . . . File containing charge density and PAW one-center occupancies used in VASP™ calculations
CKineticsDB . . . Chemical Kinetics Database
CLI . . . Command-line Interface
CPU . . . Central Processing Unit
CONTCAR . . . File containing information about the ionic positions of a structure generated in VASP™ calculations and utilized in pMuTT calculations
DBMS . . . Database Management System
DFT . . . Density Functional Theory
DIMCAR . . . File containing information about dimer convergence used in VASP™ calculations
DOE . . . Department of Energy
DOSCAR . . . File containing electronic density of state information used in VASP™ calculations
DSP . . . Digital Signal Processor
EDIFF . . . Value specifying the global break condition for the electronic SC-loop in VASP™ calculations
EDIFFG . . . Value defining a break condition for an ionic relaxation loop in VASP™ calculations
ENCUT . . . Value specifying the cutoff energy for the plane-wave basis set (Kinetic energy cutoff).
FAIR . . . Data management principles: “Findable, Accessible, Interoperable, Reusable”
FPGA . . . Field-Programmable Gate Array
Gaussian™ . . . Software for electronic structure modeling
GridFS . . . Specification for storing and retrieving files that exceed the BSON size limit imposed in MongoDB™
GUI . . . Graphical User Interface
HPC . . . High-Performance Computing
IBRION . . . Variable which determines how ions are updated and moved
IC . . . Integrated Circuit
ICHAIN . . . Variable used to control transition state methods
INCAR . . . Central input file of VASP™
IR . . . Infrared
IRC . . . Intrinsic Reaction Coordinate
IT . . . Information Technology
JSON . . . JavaScript Object Notation
KPOINTS . . . File specifying Bloch vectors used to sample the Brillouin zone used in VASP™ calculations
LCLIMB . . . Variable used to control the climbing image method
MKM . . . Microkinetic Modeling or Microkinetic Model
ML . . . Machine Learning
MongoDB™ . . . A NoSQL database program
NIST . . . National Institute of Standards and Technology
NoSQL . . . Non-SQL or Not-Only-SQL
ONIOM . . . Our own N-layered Integrated molecular Orbital and Molecular mechanics method
OS . . . Operating System
OSZICAR . . . File containing information about convergence speed and the current processing step used in VASP™ calculations
OUTCAR . . . Detailed output file of VASP™ calculations
PAW . . . Projector Augmented Wave method
pMuTT . . . Python™ Multiscale Thermochemistry Toolbox
POSCAR . . . File containing at least lattice geometry and ionic positions used in VASP™ calculations
POTCAR . . . File containing pseudopotential for atomic species used in VASP™ calculations
qRRHO . . . quasi-rigid Rotor Harmonic Oscillator
QST2 . . . Quadratic Synchronous Transit 2, requiring two structures: a reactant and a product
QST3 . . . Quadratic Synchronous Transit 3, requiring three structures: a reactant, a product, and an approximate transition state
RAM . . . Random Access Memory
RF . . . Radio Frequency
RISC . . . Reduced Instruction Set Computing
SDK . . . Software Development Kit
SI . . . Supplementary Information or Supporting Information
SQL . . . Structured Query Language or Sequential Query Language
TLS . . . Transport Layer Security
TLS . . . Transport Layer Security Protocol
TST . . . Transition State Theory
VASP™ . . . Vienna Ab Initio Simulation Package
WAVECAR . . . File containing wavefunction data used in VASP™ calculations
YAML . . . “Yet Another Markup Language” data serialization computer language and data interchange format

### DETAILED DESCRIPTION

“Heterogenous catalysis” includes catalysis where the phase of catalysts differs from that of the reactants or products. The phase of catalysts includes distinguishing between not only solid, liquid, and gas components, but also immiscible mixtures (e.g. oil and water), or anywhere an interface is present.

“Chemical kinetics” refers to the branch of physical chemistry that is concerned with the kinetics of chemically reacting systems. Chemical Kinetics can be applied to study catalysis i.e., chemical reactions occurring in the presence of a catalyst-whether the kinetics involve homogenous catalysis, heterogenous catalysis, electro-catalysis, or other forms of catalysis, as well as non-catalytic reactions (which occur in the absence of catalysts).

“Ab initio based multiscale modeling” facilitates development of mathematical models at higher length and time scales using the fundamental properties of materials, based on the laws of quantum mechanics at the atomic (e.g., the lowest) scale. The scales can include the electronic structure of materials, the thermochemistry of materials, or the microkinetics of materials.

“Microkinetics” and “microkinetic modeling workflow” includes simulating the behavior of materials at the atomic level, to obtain bond length, electronic energies, vibrational frequencies, etc. under Density Functional Theory, then utilizing a combination of statistical mechanics, thermodynamics and transition state theory, to calculate chemical equilibrium constants and rates of reaction, in order to facilitate solving mathematical system of equations representing chemical reaction kinetics of a chemically reacting system, to identify rate limiting steps, catalytic activity, predominant species, selectivity, and other emergent chemical phenomena.

An “input model” can refer to files, data and simulations belonging to one scale; or multiple sets of files, data, and simulations at one scale; or multiple sets of files, data, and simulations at multiple scales in the multiscale modeling workflow. These files, data, and simulations can correspond to either a complete microkinetic model development workflow, or a part of such workflow. “Input model” could also correspond to any other application beyond microkinetic modeling in catalysis.

In some examples, users may need to simulate atomic-scale models and employ TST and statistical mechanics to be able to calculate data for MKMs (if the MKM data is not already available). However, these needed simulations may also be collected or simulated in other contexts, or used for other analyses which would not necessarily fall under the umbrella term “MKM”. Those other usage contexts for such simulations are nevertheless considered and disclosed herein.

OpenMKM is a multiphysics and multiscale software aimed at Chemical Engineers interested in modeling chemical kinetics for heterogeneous catalytic reactions. OpenMKM is opensource software and is developed at Delaware Energy Institute, University of Delaware. OpenMKM is currently written in C++ and is compiled and executed from the command line. A user of OpenMKM can easily use any high-level programming language such as Python™ to utilize operating system (OS) level interfaces to execute OpenMKM. The selectability of any high-level programming language to facilitate utilization of OpenMKM is not a special feature of OpenMKM, and such selectability applies to most “executables” in a given OS. “NoSQL” can be referred to as “Non-SQL” or “not only SQL”, often based on a particular context. In the context of MongoDB™ nomenclature and MongoDB™ database deployments, a MongoDB™ database can store not only relational data but also semi-structured data, and thus the NoSQL MongoDB™ database can be said to be a “not only SQL” database. The general understanding of “NoSQL” in the context of MongoDB™ can be initially understood in the paper located at https://www.mongodb.com/nosql-explained, which is incorporated by reference.

“Metadata” as used herein is primarily directed to file or input metadata related to the content of an associated file or input, in particular the chemical kinetic content. In the context of electronic structure calculations, some examples of chemical kinetic metadata can include DFT computational settings, atomic structure, PAW pseudopotentials, basis set, KPOINTS mesh, vibrational frequencies wherever applicable, or convergence status. In the context of thermochemistry, some examples of chemical kinetic metadata can include the vibrational properties of chemical species obtained from electronic structure calculations, as well as information about the elementary reaction steps and catalyst site, which can be useful to obtain the thermochemistry and kinetic parameters for a given microkinetic model.

In the context of microkinetic models, some examples of chemical kinetic metadata can include the reactor conditions, list of reactions, thermochemical and kinetic properties, or product composition at the output. As the information from one scale (electronic structure, thermochemistry, microkinetics) can be required to develop the models from other scales, the source of metadata associated with one scale can be collected from multiple scales. Metadata also includes information provided by users to CKineticsDB. Non-exhaustive examples of such metadata include descriptions of chemical species, which may not be obvious from simulation files; information about the researcher or information provided by the researcher such as a summary or abstract; and software information. Such metadata can be collected in a pre-determined format in a readMe.xlsx MS Excel file, and in some examples is mandatory. This metadata can also be used in a user interface. This definition of metadata does not disavow typical file or input metadata, such as file names, file sizes, file and network protocols, access rights, or stored creation and updating dates. While the disclosed materials primarily describe heterogeneous catalysis on solid materials, the infrastructure disclosed holds also for many other applications. Examples of such applications outside the heterogeneous catalysts include: (1) homogeneous catalysts used in making organic molecules, with pharmaceuticals being one of the applications; (2) electrochemical systems used in fuel cells and synthesis of chemicals, fuels, and products, such as the conversion of carbon dioxide and the hydrogen production from water, among many examples—the emerging renewable energy sector cares employs these systems; (3) atmospheric chemistry such as ozone depletion, nitrogen oxide fate—this is an environmental application; (4) aquatic (water in all of its forms from rivers to the ocean) and soil chemistry happening in the environment.

Developing a microkinetic model from scratch can take several weeks, months or years of work, depending upon the complexity of the problem the microkinetic model seeks to inform. In developing a microkinetic model, researchers need to explore one or more catalyst materials, elucidate and simulate their atomic structures, discover or propose reaction pathways and calculate their kinetics, and perform other thermochemical analysis, etc. The time required to complete these tasks can be very large due to the combinatorial nature of the problem: often the problem can require a high number of exploratory electronic structure calculations, potentially using Density Functional Theory (DFT). The exploratory electronic structure calculations are often the most computationally expensive step in the MKM development workflow. Due to this high computational expense, the computational effort required to develop an MKM using data generated from DFT is disproportionately high: fairly large number of computations are performed in an exploratory manner, as opposed to the computations which are finally used in the making of MKMs.

However, even this finalized subset of electronic structure calculations associated with the finalized MKM can amount to thousands of hours of computational time. The complexity of a given reaction chemistry system is directly the result of the combinatorial explosion of reaction steps that could occur when a fairly large number of chemical species (e.g., anything larger than 10-20 species, in particular stable, long-lived species which could further result in several short-lived reaction intermediates which come into existence during the chemical process) participate; in addition to the added complexity of the number of types of catalytic sites where the reaction can occur.

Thus, having pre-existing MKMs with data at the three chemical kinetic scales of electronic structure calculations, thermochemistry, and microkinetic modeling, saves time, effort, and cost to develop the MKM. Pre-existing, indexed MKMs can be used directly to explore reaction kinetics and identify optimum reaction conditions as per the parameters at real-world and higher scales of theory. Reaction mechanisms developed from an existing MKM can be reused and repackaged (as a subset) for a new model for a different reaction chemistry. Similarly, subsets of the stored MKM's reaction mechanism can be used to formulate a separate MKM, as per the chemical compatibility of the user's research. Indexed access to such MKMs, in particular the electronic structure data used to build the existing MKMs within CKineticsDB, tremendously reduces the need for all the background work mentioned above to the very short time required to download data from CKineticsDB, which is generally of the order of seconds or minutes, depending on the size of the data being downloaded and computational processing power.

Each electronic structure calculation can be computationally expensive: potentially taking from several CPU hours to several CPU days. Computational time generally grows exponentially with increasing number of electrons simulated and computational time varies greatly with implementation methods of electronic structure calculation. Additionally, running an MKM simulation can take a few milliseconds to several of hours depending on the complexity of the MKM-system. The time required to run an MKM simulation is directly related to the total number of reactions and the total number of participating chemical species, and the number of other chemical kinetic simulation inputs, outputs, and interstitial products. CKineticsDB provides the outputs at each scale of theory, thereby eliminating the simulation time required to obtain results from the input files.

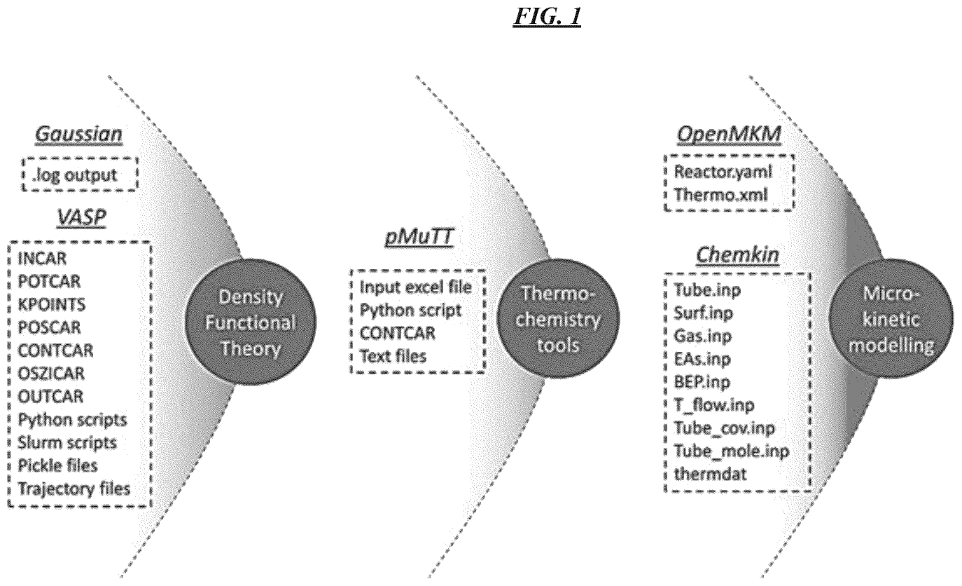

Types and Scope of Stored Data. CKineticsDB stores the unaltered, curated simulation files from the multiscale modeling workflow at three scales: (1) electronic structure calculations (e.g., DFT) input and output; (2) statistical mechanics input and thermochemistry output; and (3) MKM input data. The files in FIG. 1 represent the general data set stored within CKineticsDB. CKineticsDB covers DFT calculations associated with the VASP™ (and with VTSTTools) and Gaussian™ software. For MKM simulations, files associated with Chemkin™ and OpenMKM are stored. Files for pMuTT, which is used to perform thermochemistry and equilibrium calculations and generate input files for Chemkin™ and OpenMKM, are also stored. Files necessary to reproduce the results of a publication are available from the database while tailoring out redundant and large files that can be generated using the files available in the database. CKineticsDB stores all the file types from the software applications covered, including any code, such as work done using Atomic Simulation Environment (ASE) in Python™, shell scripts, and anything else. CKineticsDB can include files from other software programs beyond the ones covered here, including software programs for running simulations (e.g. DFT calculations, thermochemistry and kinetic parameter calculations, and MKMs) associated with the multiscale modeling workflow.

Data Organization Policy. There is no industry-wide data organization policy for ab-initio-based multiscale modeling data for catalysis. Moreover, data organization practices can vary, even within a research group. An essential facet of CKineticsDB is to provide comprehensive software files. This provisioning requires a file organization specification to ensure data uniformity and standards for uploading data. Detailed specifications are established for organizing the required files. These standards and specifications cover top-level organization and details of organizing DFT calculations based on the nature of species and type of calculations, thermochemistry data, and MKM data, and are meant to identify the important data and files, trim the redundancies, and ensure that all the files required to reproduce a researcher's work are stored. This exercise does not require re-running any calculations or generating new files but demands organizing the existing research folders/files associated with a publication into a pre-determined hierarchy. Once a project's files are organized, they can be readily uploaded into CKineticsDB with minimal or no additional effort.

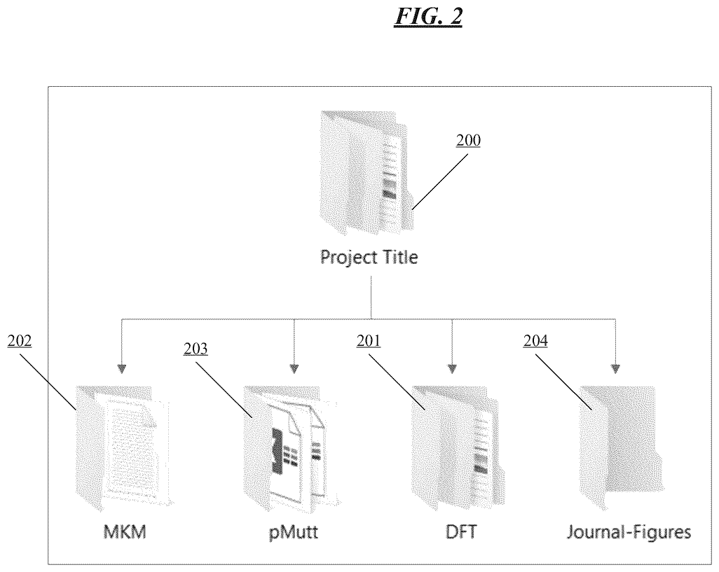

The workflow depicted and described in FIGS. 2-7 is written for a catalysis project with a research scope spanning DFT, thermochemistry, and MKM. Files associated with software that are not included in this document but are a part of the catalysis project publication should also be submitted and recorded in the “readme” file to provide sufficient provenance regarding the catalysis project publication.

First, all the files that contributed to the results published in a catalysis project publication 200 need to be classified into top-level folders such as DFT 201, MKM 202, and pMuTT 203. A representation of the top-level file organization is shown in FIG. 2.

Within a typical DFT directory 201, a typical DFT project 301 might involve relaxation calculations for gaseous species, pure bulk structures, adsorbates, and more, along with various transition state probing methods. With VASP™, these can be nudged elastic band (NEB) calculations, dimer calculations, frequency calculations, and other calculations. With Gaussian™, there can be scan (scanning the potential energy surface) calculations, Quadratic Synchronous Transit-Guided Quasi-Newton calculations with particular molecule specifications (QST2, QST3), intrinsic reaction coordinate (IRC) calculations, and other calculations. Optionally, a DFT project 301 can also have auxiliary post-processing analysis such as Density of States, Bader charge density analysis, etc. Additionally, data organization policies for other custom analysis, such as phase diagrams, adsorbate-adsorbate interactions, AI/ML data-driven approaches can be utilized. Within the DFT directory 201, it is preferable that the naming convention of the species should be consistent with the journal article.

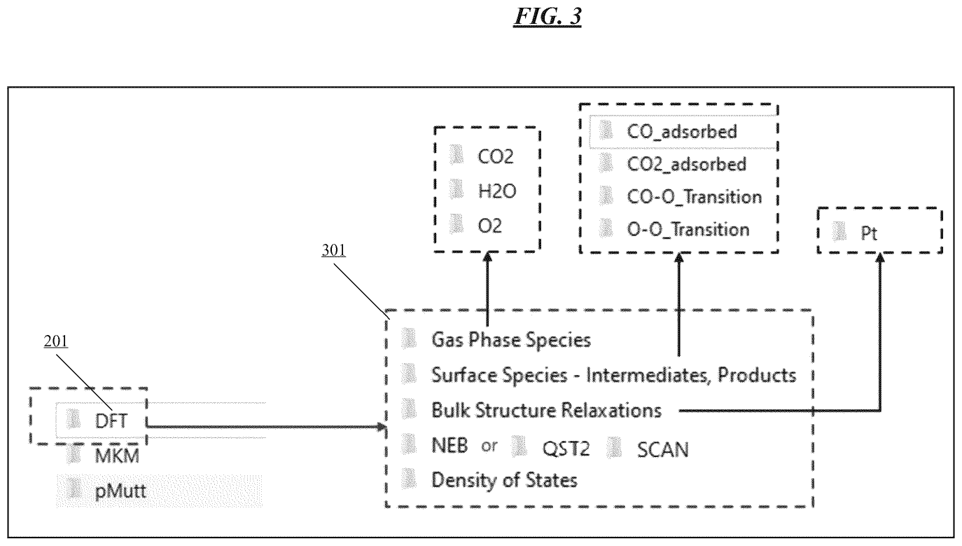

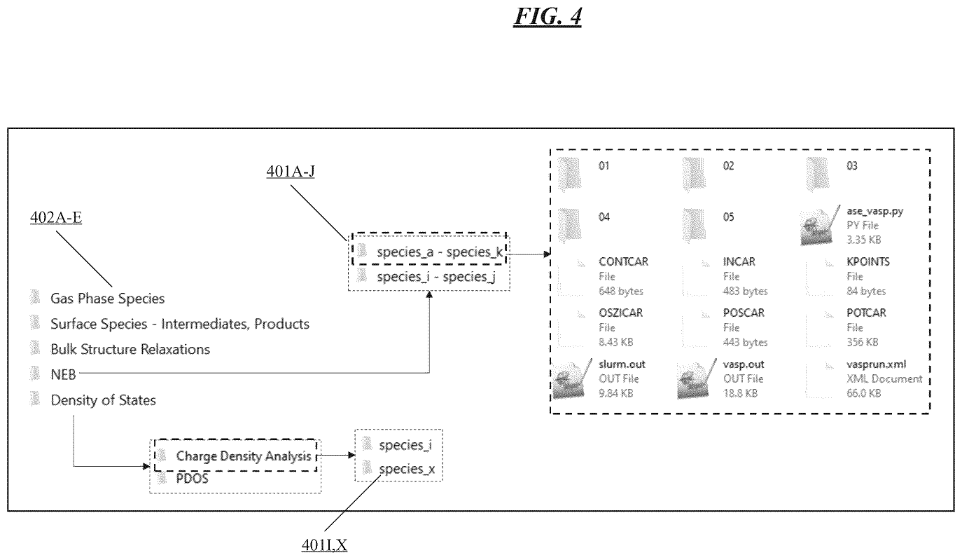

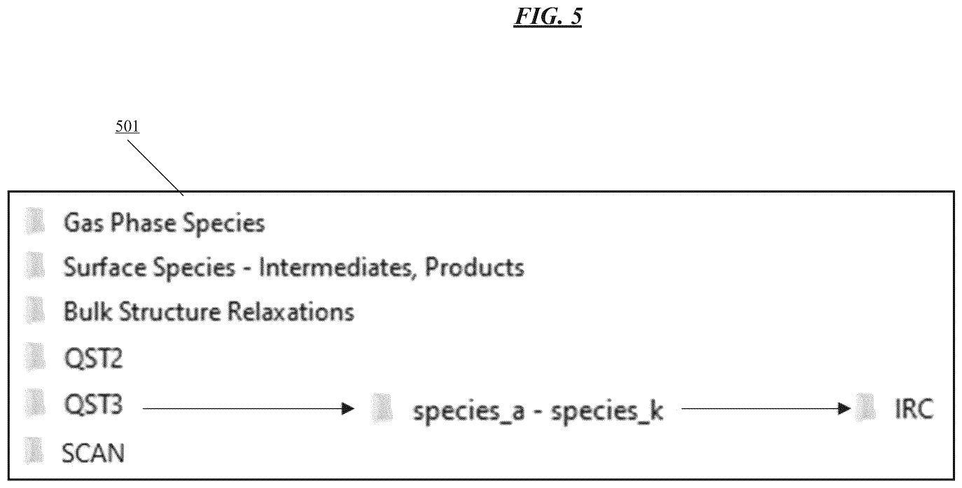

The files belonging to a DFT relaxation calculation should be classified based on the molecular species 301, and the species' sub-directories should be grouped based on the state, as shown in FIG. 3. Other DFT analyses, such as NEB, SCAN, QST2, QST3, and Density of States should also be included in the DFT directory 201 in separate sub-subdirectories 301, 402A-E, 501, as shown in FIG. 3, FIG. 4, and FIG. 5. The NEB directory for a given elementary reaction step preferably contains all the required DFT folders, such as the initial state, final state, and intermediate images for the calculation. Further analysis, such as the NEB-climb up, frequency analysis, and dimer, preferably resides as a sub-directory within the NEB directory of that transition state and be named accordingly. The basic files (NEB-input and others) for a particular transition state calculation can be kept directly in the directory of that transition state, as depicted in FIG. 4.

Similarly, when working with Gaussian™, transition state calculations 501, such as SCAN, QST2, QST3, and others, should be kept in separate directories. Further analysis, such as IRC for a transition state, should be kept inside the sub-directory for the corresponding species' transition state calculation, as shown in FIG. 5.

The files from vibration analysis for a ground state or a transition state should be placed in a sub-directory inside the respective ground state or transition state directory. The Density of States directory should contain separate sub-directories for unique species. The same rule also applies to Bader charge density analysis if it has been performed.

A sub-directory for a DFT calculation should ideally include the following files: VASP™ files-INCAR, POSCAR, POTCAR, KPOINTS, CONTCAR, OSZICAR, OUTCAR, vasp.out, vasprun.xml; Gaussian™ files: input.com, output.log; Slurm files: slurm.out; Python™/MATLAB™ files: Python™ script used to run ASE and generate inputs to VASP™, scripts for ONIOM calculations in Gaussian™, etc. The researcher should add other files that were important for the project, especially those necessary to reproduce the results. For example, a dimer calculation should have the DIMCAR file. The researcher should preferably avoid including large files such as WAVECAR, CHG, and CHGCAR. With calculations that require the CHG/CHGCAR/DOSCAR files etc. pragmatic judgment should be used by the researcher to determine which files should be stored. If these files can easily be generated in the future, the researcher preferably should archive the scripts to re-run the calculation, so that a future researcher can regenerate these generable files. Preferably, the DFT runs done before the final DFT calculations for testing hypotheses or other investigations should not be included. Only the final DFT runs should preferably be included in these directories that were directly part of the results in the publication.

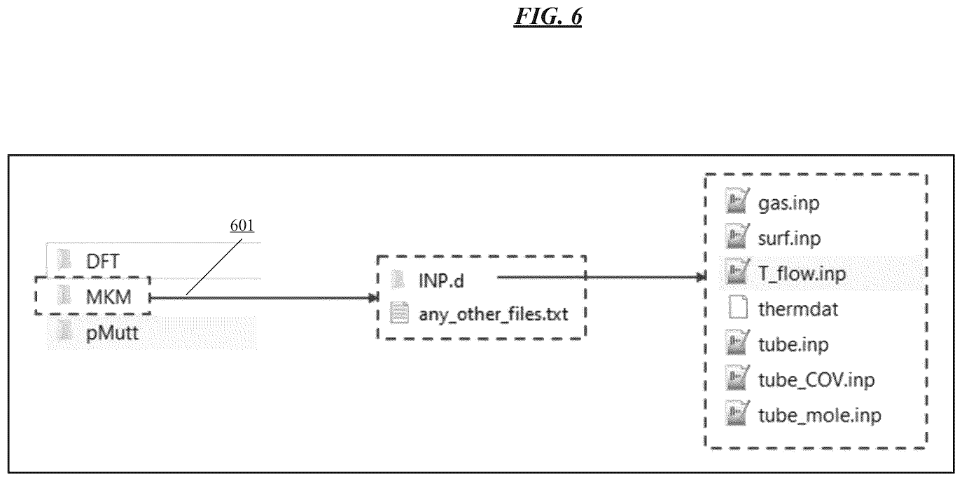

The MKM directory 601 should contain the input files for Chemkin™ or OpenMKM in a sub-directory, as shown in FIG. 6. Any other supporting files and output files can be placed along with the input folder for Chemkin™/OpenMKM, in the MKM directory. All the input files for Chemkin™/OpenMKM should be included. These files should preferably suffice to run the MKM simulation that gave the results presented in the publication. If multiple MKM runs were done at different temperatures, concentrations, etc. that directly led to your results, these should also be included in separate sub-directories inside the MKM directory with appropriate folder names.

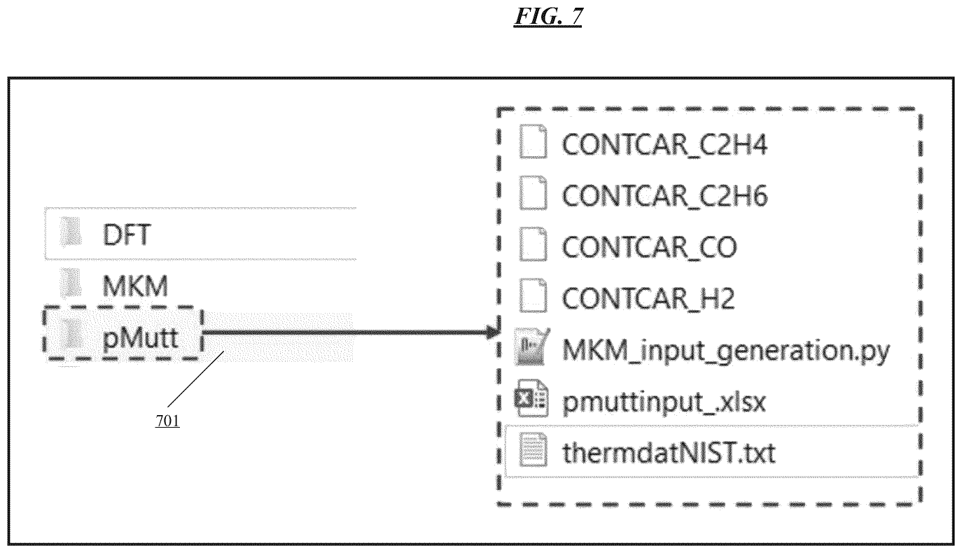

The pMuTT directory 701 should contain the pMuTT input MS Excel sheet(s) that contains the species, reactions, catalyst sites, and other information necessary to generate the MKM input files, as shown in FIG. 7. The pMuTT directory should also contain the Python™ script used to run pMuTT and any other supporting files, such as CONTCAR files or files containing NIST data. Any other calculations, such as quasi-rigid Rotor Harmonic Oscillator (qRRHO) approximations, etc. should be included in separate sub-directories under the pMuTT directory with appropriate folder names.

Additionally, a Journal-Figures directory 204 can contain the “recipe” for all the figures, tables, and other graphics (say vector graphics or POV-Ray images) that were a part of the publication. The Python™/MS Excel/MATLAB™/Origin scripts used to generate the plots/figures in the publication should be kept in this directory. All the supporting files that provide data to the Python™ script or elsewhere to generate the images should also be kept in this directory. The researcher should use pragmatic judgment to identify all the post-processing required for the graphic-making workflow and archive that required post-processing.

Compliance of the inbound data with the top-level directory hierarchy described in FIGS. 2-7 is a must to be able to utilize CKineticsDB. Consistent organization practices make it easier to understand the stored data and ensure uniformity across data sets to build subsequent software tools that use the stored data. The database is populated with data sets consisting of simulation files used to generate the results shown in published papers. The data are curated programmatically to check for computational diligence and manually to assess anomalies.

The directories shown in FIGS. 2-7 may include additional files, directories, or sub-directories, which if included may be utilized, removed, or ignored by the CKineticsDB systems and methods.

Infrastructure. To efficiently manage data storage and broaden the scope for extensibility, CKineticsDB uses a MongoDB™ (v4.2.21) DBMS as a back end and a Python™ (v3.9.15) application as a front end-However, future versions of MongoDB™ and Python™ are contemplated, as well as alternative databases, back ends, alternative coding languages, applications, and front ends. The application or front end provides a user interface, converts the unaltered data from multiple sources into a MongoDB™-compatible format and vice versa, and enables the development of features utilizing the stored data.

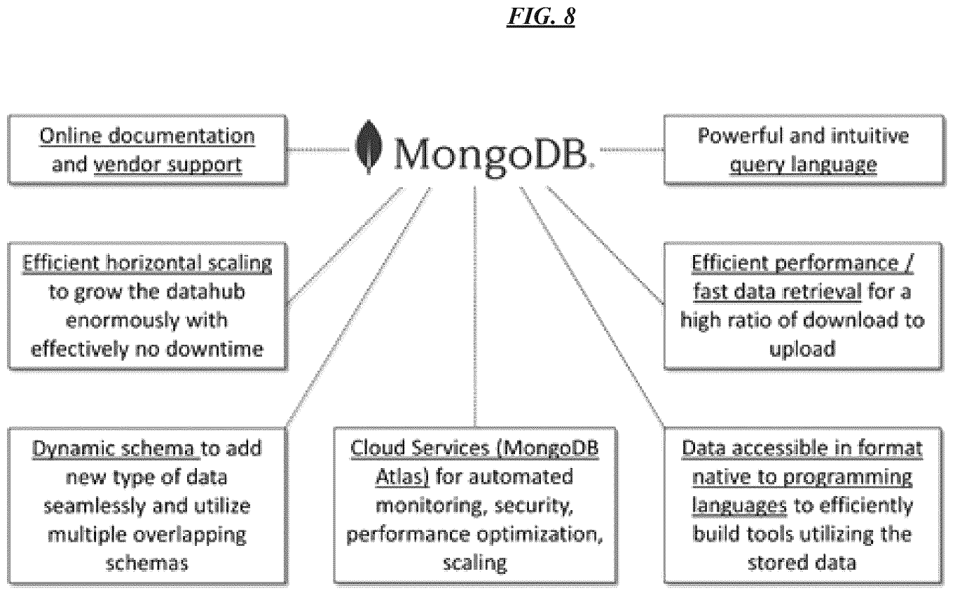

Database Management System (DBMS). The files generated in the DFT-MKM workflow vary in format but have an underlying content consistency. Storing such semistructured data using a “Not only Sequential Query Language” (NoSQL) DBMS is optimum for retaining the information from the original files and querying the stored data. MongoDB™, a NoSQL DBMS which stores data in the form of BSON documents, has features aligned with the objectives of CKineticsDB, as shown in FIG. 8. With the ability to implement a nonrigid and nonsingular schema, MongoDB™ permits the seamless uploading of nonconcurrent data. MongoDB™ also allows multiple and overlapping schemas, aiding with managing and retrieving data selectively. The stored data can be downloaded from MongoDB™ in a universal JSON format. MongoDB™ further allows extension of the infrastructure with no downtime in user experience, owing to efficient horizontal scaling capabilities, predominant in NoSQL databases. MongoDB™ also provides the option of cloud support with automated monitoring, security, performance optimization, scaling, and more capabilities for expansion. MongoDB™ still further provides documentation and technical support from the vendor and related online forums.

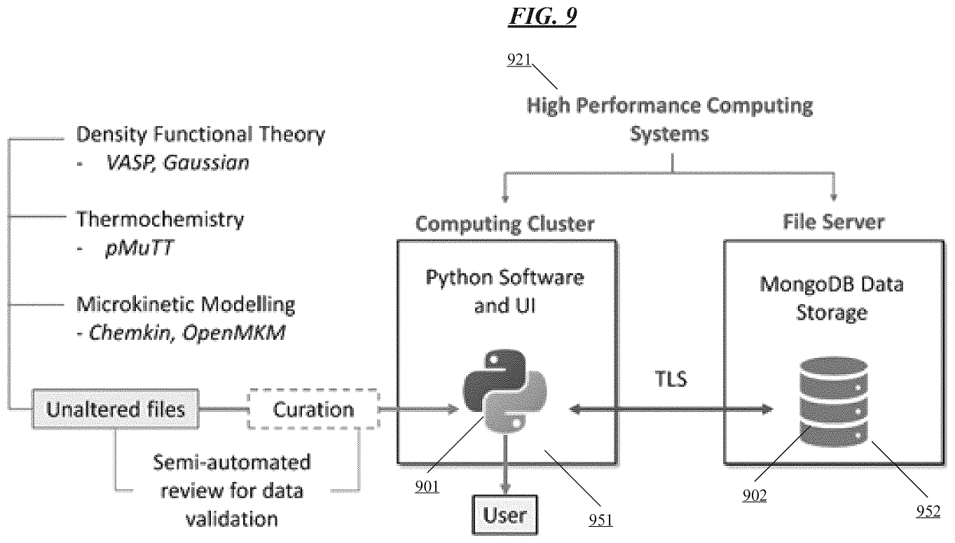

CKineticsDB Principal Repository. In this example, the CKineticsDB software application 901 is hosted on a computing cluster 951, and the CKineticsDB database 902 is on a separate file server 952, as shown in FIG. 9. The data is transmitted between the database 902 and the application 901 utilizing a Transport Layer Security Protocol (TLS), ensuring security during transit—though other security protocols are contemplated. Database storage is preferably on a file system backed by a triple-parity block storage pool, with daily snapshots shipped to a secondary server for resilience. Administrators can access the software either through this installation or through the public distribution of the software explained below. The high-performance computing cluster 921 can include several computing clusters beyond the computing cluster 951 and the file server 952. Computing cluster 951 can host additional related or unrelated applications, and may share an operating system or dynamically-allocated physical resources such as storage and processing power with those additional applications. File server 952 can host additional databases beyond the CKineticsDB 902, and the CKineticsDB 902 may include datasets and data objects not immediately relevant to the functioning of the CKineticsDB software application 901. The data stored in the CKineticsDB database 902, whether relevant to the software application 901 or otherwise, in some examples may be accessed or manipulated by other applications with access to the CKineticsDB database 902.

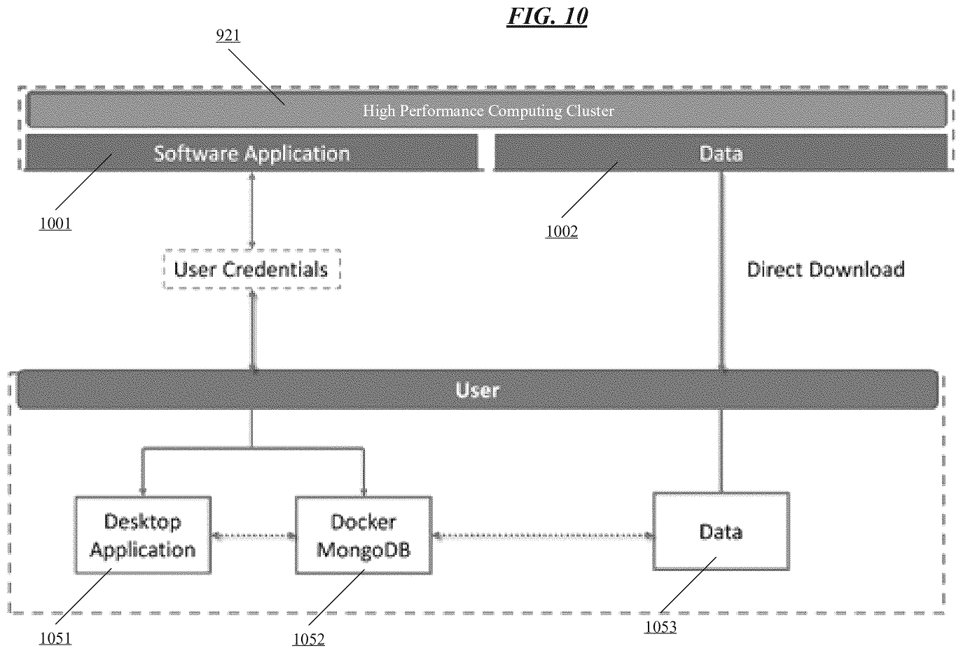

Though FIGS. 9 and 10 depict a high-performance computing cluster 921 implementing a computing cluster 951 and file server 952, CKineticsDB can be implemented on, and the high-performance computing cluster 921 and sub-components 951, 952 can be analogized to, a simple computer with a processor and a memory.

CKineticsDB Software and Database Distribution. Access to the data within the file server 952 can be provided for researchers without direct access to the high-performance computing cluster 921 via a website interface. External researchers can access the data set via an online portal accessible via the HTTPS communication protocol. Further, the CKineticsDB application 901 can be provided as a separate replicated desktop application 1051 to interact with the data sourced from the database 902, once that data has been copied locally as local data 1053, and then replicated to, inserted into, uploaded into, or accessed by a Docker container 1052 located on the personal machines of external researchers (See FIG. 10). The data 1053 can also be directly downloaded into the Docker container 1052 without the need for the additional step of downloading the data into a local directory before insertion into the Docker container 1052. In this example, the CKineticsDB software application consists of two components: (a) a Docker container 1052 with MongoDB™, in which users can use the CKineticsDB provided data or upload their own data, and (b) a desktop application 1051, replicated from the application 901 that launches a GUI and directly connects to their local MongoDB™-Docker container 1052 with all the features of CKineticsDB. Desktop application 1051 is an instance or copy of software application 1001 downloaded and/or installed on a user's device (e.g., a desktop computer, smartphone device, or another high-performance computing cluster other than high-performance computing cluster 921, as non-limiting examples). The same application 1051 in this example also provides a command line user interface to employ the features of the application 901 in its full capacity against the Docker container 1052 and facilitate integration with other software tools.

The Docker container 1052 works as a local MongoDB™ server 902, which can be connected to the desktop application 1051. When the Docker container 1052 is run for the first time, it automatically downloads the sample data set 1053 from the high-performance computing cluster 921. Users can override the default data set used by the Docker container 1052. The desktop application 1051 in this example is provided for Windows, MacOS, and Linux. This application 1051 by default connects to the Docker container 1052 working as a local replicated copy of the MongoDB™ server 902. The application can also connect to a different MongoDB™ database server preferred by the researcher with the use of a database configuration file (the default configuration file provided with the software can be modified accordingly). The application 1051 can also be used for a command line interface with the same features as the GUI but with a file-based interaction wherein researchers can request more data in one run than the GUI. The CLI can also be integrated with other programs developed by the researchers. The application's 1051 data quality assessment module can be used independently for ensuring the diligence of locally stored VASP™ and Gaussian™ based DFT calculations.

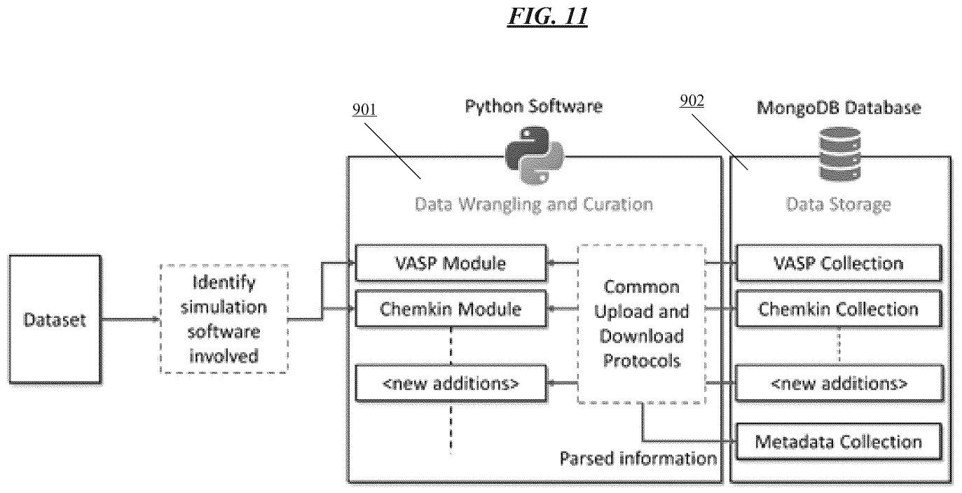

Methods. The CKineticsDB systems and methods perform three top-level functions: checking the quality of DFT calculations, uploading data, and downloading data. The software application 901 is constructed in Python™ in a modular design with separate workflows for each software whose files are stored (See FIG. 11) to handle nuances of the simulation software that generated the data. In particular, metadata are stored separately for fast data selection. The application 901 has a common central workflow to transmit data between the Python™ software 901 and the MongoDB™ database 902, once it is in a compatible format. This allows independent development to integrate a new source of files (such as a different software used to run DFT calculations) as the database 902 expands. In this example PyMongo, the official MongoDB™ driver, is used for transmitting data between Python™ and MongoDB™, along with GridFS to handle files larger than the BSON document size limit of 16 MB.

Data Quality Assessment. Developing a reaction mechanism involves many DFT calculations. Concurrence of thermodynamic quantities derived from DFT calculations with experimentally observed values can induce a researcher to overlook the accuracy of the DFT simulations. Such methodologies, including the practice of relying on the accuracy of DFT-derived thermochemistry, while ignoring the level of accuracy of DFT simulations, can lead to non-converged, insufficiently discretized, and inconsistent DFT calculations with subpar heuristics to save computational resources at the expense of accuracy. Though DFT simulations can be inspected for inaccuracy and accepted on a case-by-case basis, for reusability the calculations should surpass basic quality metrics. CKineticsDB curates the DFT calculations based on reliability standards.

The acceptable precision can vary based on the domain and research objective; however, CKineticsDB expects a minimum level of precision. While identifying nonconforming calculations, CKineticsDB also provides the recommended optimum calculation metrics wherever heuristics can be utilized. This transparent recommendation allows a researcher to make an informed decision about the acceptability of the stored data. CKineticsDB uses specific quality tests based on the type of DFT calculations (Table 1) and utilizes the corresponding quality metrics (Table 2).

TABLE 1
Quality Tests for Different Types of DFT Calculations

| Software | Calculation | Quality Test(s) |
|---|---|---|
| VASP ™ | Ionic relaxation | Convergence, Kpoints, Encut |
| VASP ™ | Dimer | Convergence, Curvature, Kpoints, Encut |
| VASP ™ | (Climbing - /) Nudged elastic | Convergence of the highest energy |
| | band (inclusive of all images) | image, Kpoints, Encut |
| VASP ™ | Individual NEB image | Convergence |
| VASP ™ | Frequency Analysis | Frequencies assessment, Kpoints, Encut |
| Gaussian ™ | Optimization | Convergence |
| Gaussian ™ | Frequency Analysis | Frequencies assessment |

TABLE 2
Metrics and Assessment for Quality Tests
for Different Types of DFT Calculations

| Quality Test | Metrics | Available result |
|---|---|---|
| Convergence | Last electronic and ionic steps | Passed/Not passed; Trajectory of |
| (VASP ™) | should be within EDIFF and | the last N (≤20) ionic steps |
| | EDIFFG, respectively | |
| Kpoints | Subsections should be greater | Passed/Not passed; Identified |
| | than or equal to the | lattice structure, used Kpoints |
| | recommended values based on | mesh scheme, minimum |
| | the lattice structure and mesh | recommended subsections and |
| | | used subsections |
| Encut | Kinetic Energy cutoff (ENCUT) | Passed/Not passed |
| | should be greater than or equal | |
| | to the highest PAW | |
| | pseudopotential (ENMAX) | |
| Curvature (for | Curvature should be negative | Passed/Not passed |
| dimer) | | |
| Frequencies | A single imaginary frequency | Passed/Not passed; Values of |
| assessment for | | imaginary frequencies if more |
| transition state | | than one |
| Convergence | Identify forces and | Passed/Not passed |
| (Gaussian ™) | displacement assessment by | |
| | software | |

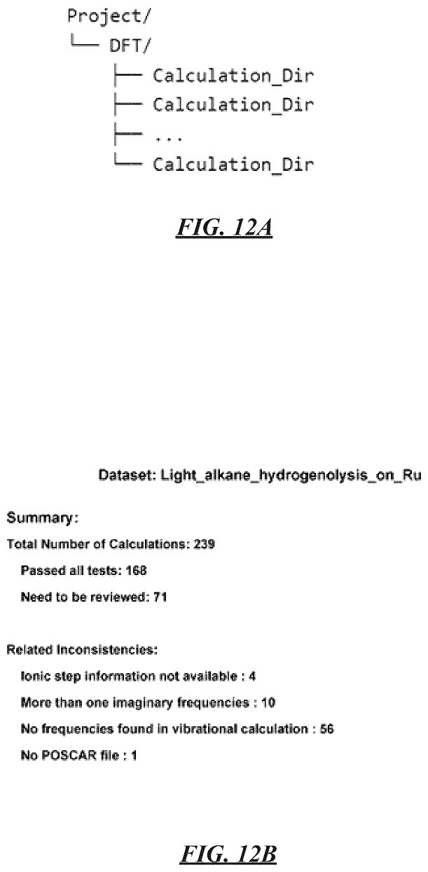

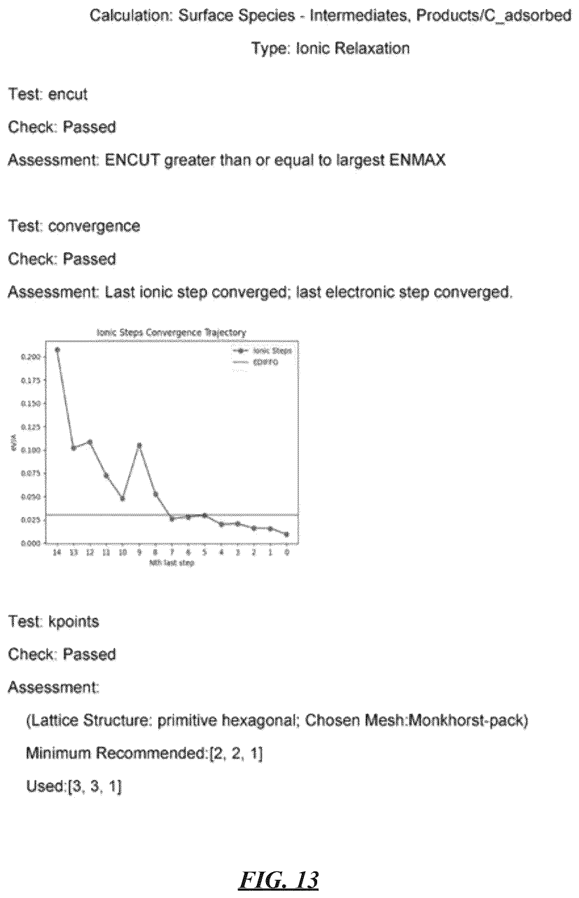

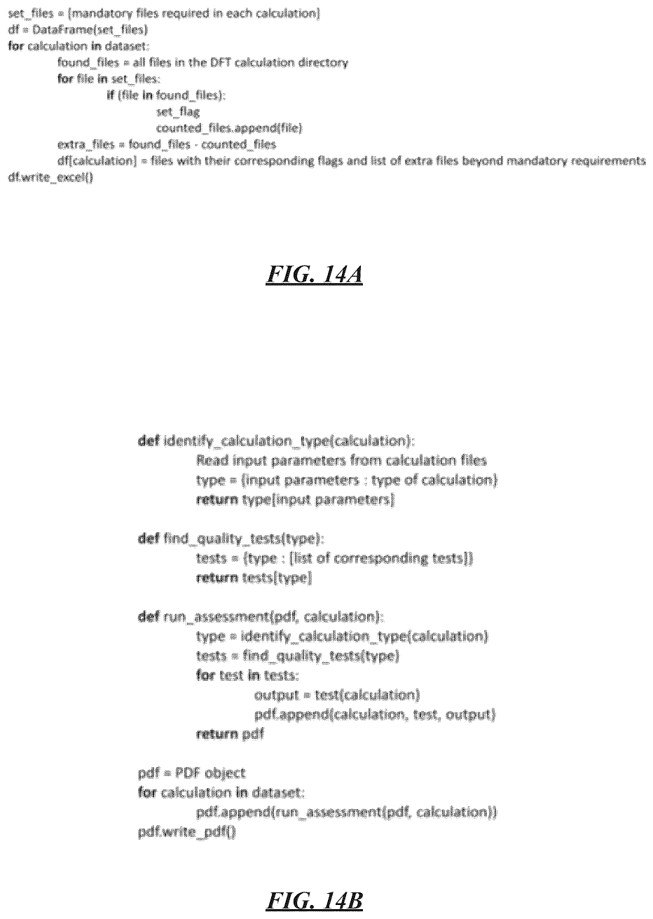

The data quality assessment feature of CKineticsDB takes in the path to the project directory containing the DFT calculations stored in a predetermined hierarchy (See FIG. 12A). The quality assessment algorithm will identify the software used to run the calculations and the type of the calculations from the files present and their contents, respectively, along with extracting relevant information to run quality tests based on the type of the calculation. Preferably, the calculations in one data set must be originating from the same DFT software to be tested in one data quality assessment run, containing calculations from VASP™ or Gaussian™, but preferably not both on a single run basis-one run of the data quality assessment feature can include a number of VASP™ calculations, while a separate run can include a number of Gaussian™ calculations. However, it is contemplated that the data quality assessment feature may be configured to assess files in combination from multiple software tools, DFT or otherwise. The files used for assessing DFT calculation quality and the information extracted from them are included in Table 3. Other files may be used to assess DFT calculation quality, and may include information extractable from those files. The results of the DFT calculations' quality assessment are provided in a PDF file with the first page showing the summary (See FIG. 12B) and the subsequent pages having the assessments for each individual calculation (See FIG. 13) in the data set. The missing files identified by the module are also marked in an MS Excel file or another format of spreadsheet file such as a comma-separated value file, generated by the software. The pseudocode for the generation of the MS Excel file is shown in FIG. 14A, and the pseudocode for the generation of the PDF file is shown in FIG. 14B. Every stored data set in the database also contains a quality assessment which will be downloaded if a researcher downloads any DFT data. The quality assessment feature works independently of the database and researchers can generate the results documents for any of their data sets or DFT calculations generated locally. However, before uploading, any data set with DFT calculations needs to be first passed through the quality assessment module and the result files of the module must be present in the project directory. The availability of this information enables a researcher who downloads the DFT calculations to make an informed decision on the viability of the data for their application.

The hierarchy of FIG. 12A may include additional or different elements and levels than those depicted. The summary of FIG. 12B may include additional or different reported values than those depicted. The assessment of FIG. 13 may include additional or different reported values and graphs than those depicted. The pseudocode of FIGS. 14A-B may include additional or different function declarations and definitions than those depicted. Existing quality tests may be modified, and new quality assessment tests may be added for assessing the data quality across multiple scales of theory, including non-exhaustively DFT calculations, thermochemistry and kinetic parameter calculations, and MKM.

TABLE 3
Files for Assessing DFT calculation quality and Extracted Information

| | | |
|---|---|---|
| File | Utilization | Extracted Information |

VASP ™

| INCAR | 1. | Identify type of calculation. | 1. | IBRION, ICHAIN, LCLIMB |
|---|---|---|---|---|
| | 2. | Identify convergence | 2. | EDIFF, EDIFFG |
| | | parameters. | 3. | ENCUT |
| | 3. | Cutoff energy from the plane- | | |
| | | wave basis set | | |
| POSCAR | Calculating norm of the lattice vectors | | Scaling factor and lattice vectors | |
| | and reciprocal lattice vectors | | | |
| KPOINTS | Compare the chosen mesh with that | | Used KPOINTS and chosen mesh | |
| | calculated based on the lattice | | | |
| | vectors | | | |
| POTCAR | Check if the highest ENMAX of an | | Unique elements in the system | |
| | element is less than or equal to the | | | |
| | set ENCUT parameter | | | |
| OUTCAR | 1. | Check if calculation is converged. | 1. | Total energy change after each |
| | 2. | Check the distribution of | | electronic loop and change in |
| | | imaginary and real frequencies | | forces/energy after each ionic |
| | | | | loop. |
| | | | 2. | Listed frequencies |

| DIMCAR | Check if a dimer calculation is | Curvature and Forces |
|---|---|---|
| | successful | |

| | | |
|---|---|---|
| OSZICAR | Check if the maximum energy image | Energy and the change in total |
| | in an NEB calculation is converged | energy in the last step. |

Gaussian ™

| | | | | |
|---|---|---|---|---|
| Log | 1. | Identify type of calculation | 1. | Input parameters |
| | 2. | Check if calculation is converged. | 2. | Convergence flag printed by the |
| | 3. | Check the distribution of | | software |
| | | imaginary and real frequencies | 3. | Listed frequencies |

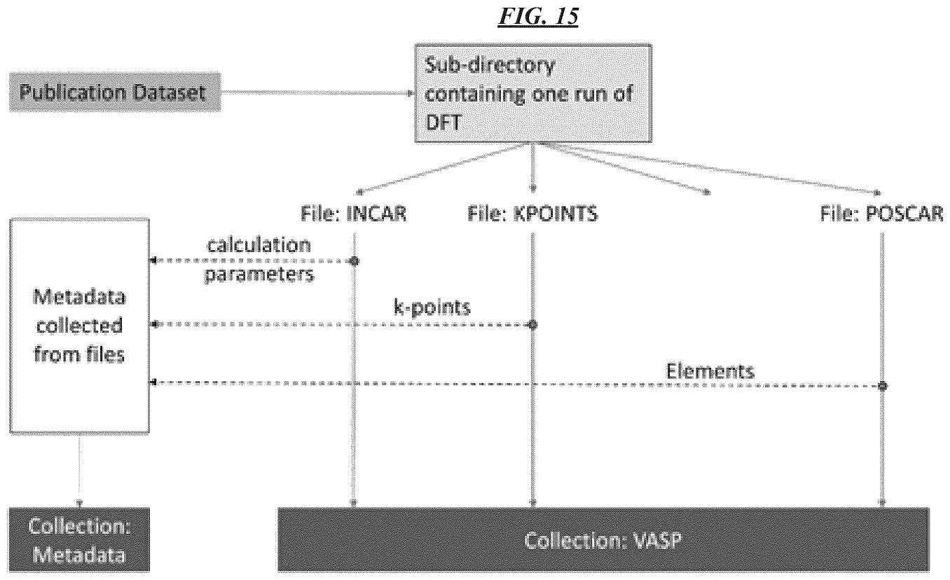

Upload. Owing to the dense information in simulations, file I/O operations need to consider the extraction of essential results, simulation parameters, and catalyst properties while retaining encodings for re-using the files. Files required as dependencies to re-run a simulation are stored in a manner which ensures accurate reconstruction with all their encodings intact. Some files contain important parameters for identifying the chemical information, such as the reaction conditions, reactor parameters, and simulation parameters. Files with dense and valuable metadata that cannot be reconstructed are parsed, and the relevant information is stored as queryable data, and the original file is stored separately. If the metadata-rich files are structured and can be reconstructed accurately, they are broken down into multiple queryable components. The former results in two copies of the data from one file, while the latter is preferred and saves space. In all cases, any metadata to be utilized in the user interface is extracted and stored separately for easy retrieval and selection when running a user interface. A schematic representing the metadata extraction when uploading a VASP™ DFT calculation is shown in FIG. 15. CKineticsDB takes as input the path to the project directory which needs to be uploaded. The data within the directory first need to be organized by the data contributor or researcher as per the CKineticsDB Data Organization Policy described above across FIGS. 2-7. The data are curated programmatically by the CKineticsDB quality assessment module to ensure computational diligence and manually to assess anomalies and provenance. The results of the quality assessment are required to be included in the data set to commence uploading. Further information and corrections can be required from the data contributor or researcher based on the results of the assessments.

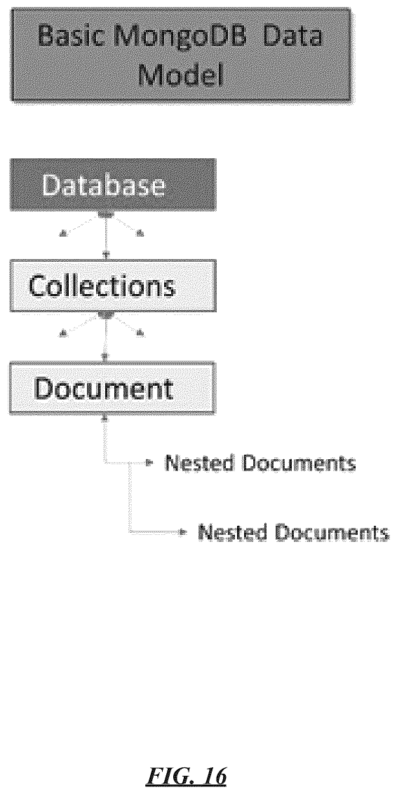

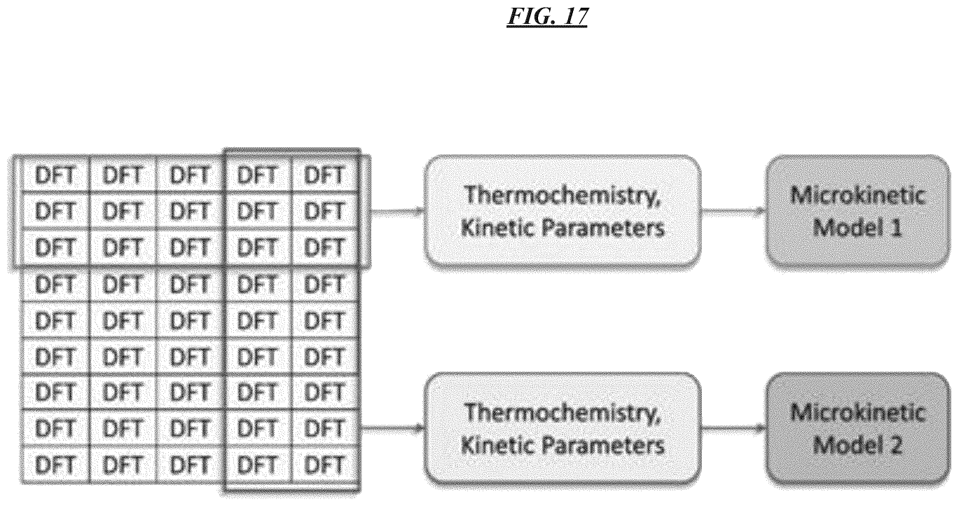

Data Model Design. In MongoDB™, and many NoSQL database implementations usable by the CKineticsDB, data are stored as a BSON document. A MongoDB™ database is comprised of “collections”, and each collection contains several BSON documents (FIG. 16). In MongoDB™, and some BSON and JSON-based databases in general, each document can have a varied schema based on which the document can be queried and, thus, retrieved selectively if stored with adequate and relevant metadata as a part of the schema design. The CKineticsDB data model follows a referencing-based schema and reflects the many-to-many relations in the DFT-based MKM workflow. At a top level, a data set is represented as a collection of files belonging to one publication and individually accessible DFT calculations and MKMs. The metadata of the data at three scales is linked to allow retrieving files at each scale independently of each other and with their associated complete workflow. This data model leads to low redundancy in storage as DFT data shared between MKMs within a data set do not need to be embedded in each, as shown in FIG. 17. Similarly, duplication of data at each scale can be reduced.

CKineticsDB has separate collections for each software program whose files are stored. This separation allows handling similar files belonging to a unique source independently from other files, establishes exclusive data management practices for each source software, and aids in the modular expansion of the datahub without affecting the existing data and workflow.

Download. CKineticsDB provides user-friendly features to easily access data from predefined subworkflows and standalone calculations from the multiscale modeling workflow. Thus, the data and files required for common recurring applications can be generated without any extra work by the researcher. These features non-exhaustively include:

Accessing comprehensive paper-related files to accurately reproduce published results: A complete data set can be downloaded in one run by selecting the publication of interest. This complete data set can include all the DFT calculations, MKMs, and thermochemistry data files associated with pMuTT along with any peripheral files.

Accessing DFT data relevant to the user's interest: Researchers can filter through multiple criteria to download specific DFT calculations based on calculation parameters and catalyst properties.

Accessing DFT calculations and thermochemistry data associated with selected reactions from available MKMs: Researchers can select reactions from a mechanism and download DFT calculations associated with the species in the reactions, the complete microkinetic model, and create a new pMuTT input file with the thermochemical properties of the species involved.

All of the above features provide data in a JSON format or directly in the format of the original software that generated the files. The latter allows researchers to directly run calculations in the respective software without writing any code to create the input files.

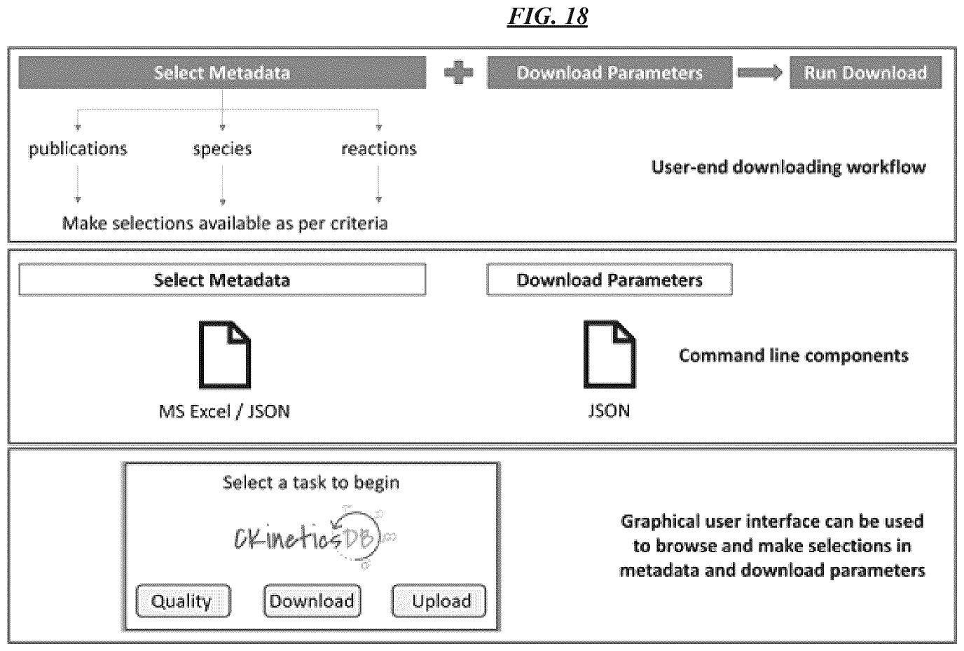

User Interface and Download Parameters. CKineticsDB in this example provides a graphical and a command line user interface. Both can be used to check quality, upload data, and download data. For data quality assessment and for uploading the data, once the data set has been curated and organized as per the norms mentioned in this document, the GUI can be used to browse and select the directory. Alternatively, the command line interface requires a command line argument for the path to the directory for quality assessment or for uploading to the database. For downloading, the command line user interface generates a metadata file in either MS Excel or JSON format in which researchers can make selections based on the metadata parameters (Table 4) as per the data they want to download. Other selection parameters may be provided to the researchers for selection. A download parameters JSON file is also required which includes additional parameters (Table 5) based on which data will be downloaded. Other download parameters may be provided to the researchers for selection. The GUI performs the same tasks as the CLI, aiding a human user in better perceiving the available data, and provides a clickable workflow for selecting metadata and download parameters. An overview of the user-end downloading workflow is depicted in FIG. 18.

TABLE 4
Metadata Parameters to Select Data for Downloading

| Top-level | | |
|---|---|---|
| Criteria | Parameter | Description |
| Publications | paper_title | Title of the published paper |
| | DOI | DOI of the published paper |
| | institute | All of the institutes associated with the |
| | | published paper |
| | project | Name of the data set submitted to |
| | | CKineticsDB |
| Species | original_nomenclature | Name of species as used by the data |
| | | contributor |
| | description | Description provided by the data contributor |
| | | to clarify the species original_nomenclature |
| | smiles | SMILES strong of the species, if available |
| | software | DFT software used to run the calculations |
| | software_version | Version of the DFT software used to run the |
| | | calculation |
| | catalyst | Catalyst in the DFT calculation |
| | promoters | Promoters used to modify the catalyst |
| | catalyst_surface | Catalyst surface on which the calculation is |
| | | performed |
| | functional | Pseudopotential used in the DFT calculation |
| | catalysis_site | Site on the catalyst where the calculation is |
| | | performed |
| | project | Name of the data set submitted to |
| | | CKineticsDB |
| | paper_title | Title of the published paper |
| Reactions | original_nomenclature | Reaction string as used by the data |
| | | contributor |
| | species | Species names as seen in the reaction string |
| | species_description | Description provided by the data contributor |
| | | to clarify the species in the reaction string |
| | catalyst | Catalyst in the DFT calculation |
| | promoters | Promoters used to modify the catalyst |
| | catalyst_surface | Catalyst surface on which the calculation is |
| | | performed |
| | catalysis_site | Site on the catalyst where the calculation is |
| | | performed |
| | paper_title | Title of the published paper |

TABLE 5
Parameters to Specify Data Downloading Preferences

| Parameter | Description |
|---|---|
| destination | Absolute path of the directory in which the |
| | files should be downloaded |
| metadata_json | Format of the metadata file in which a |
| | researcher/machine has made their |
| | selections. This file can be generated by |
| | CKineticsDB for the researcher. |
| modules | One or more of [“DFT”, “MKM”, “pMuTT”]. |
| | Files associated with the included modules |
| | will be downloaded. |
| criteria | Only one of the “publications” or “species” |
| | or “reactions.”. A researcher/machine |
| | should make selections in only one criteria |
| | in the metadata file for one run. |
| mechanism | “True” to generate a new pMuTT input MS |
| | Excel sheet with only the selected species |
| | and reactions. |
| download_json | Format of the downloaded data. |

Stored Data Metrics. CKineticsDB can include at least 14,000 DFT calculations, which comprise gas phase calculations, bulk structure relaxations, adsorbate relaxations, and transition-state calculations, and can cover other types of calculations. The catalysts can include non-exhaustively: pure metals (Ag, Au, Cu, Ir, Ni, Pd, Pt, Rh, Ru), metal oxides (Al₂O₃, ReOₓ, TiO₂, ZrO₂), and zeolites, with various promoters and different configurations. CKineticsDB is configured to store or include the MKM files for several reaction mechanisms, non-exhaustively including hydrogenolysis, dehydrogenation, hydroformylation, hydrodeoxygenation, C—O bond activation, acylation, and other reaction mechanisms, with separate models based on the catalyst conformations. This includes surface reactions for AHₓ—H (A=C, N, and O) scission, C—C scission, and AHₓ adsorptions and other reactions.

Compliance with FAIR Guiding Principles. CKineticsDB aligns with the FAIR guiding principles for scientific data management, and concurrence with its components is as described below:

Findable. CKineticsDB collects important domain-relevant metadata from computational files and from the data contributor or researcher. The metadata, from multiple levels of the multiscale modeling workflow along with those from the publication, are available to the researchers. CKineticsDB provides sufficient documentation for researchers to reach out to the operators for any further information to access the stored data. Under the distribution mechanism employed by CKineticsDB, the complete data and metadata are available on globally unique and persistent URLs. The embedded publication specific data sets and metadata provide the DOIs associated with the publications whose data are archived. Accessible. CKineticsDB is available over the Internet using the universal, open, free, and standard HTTPS communication and authorization protocol. While the data and metadata are available freely online, access to software can require user credentials for security reasons. The metadata are also available for download separately from the data. Interoperable. The metadata and data are available separately in formats readable by humans and machines. CKineticsDB provides built-in features to download data corresponding to subworkflows and parts of a data set based on catalyst properties, reactions, and computational parameters, while also providing sufficient information linking the downloaded data to the research project the downloaded data belong to. CKineticsDB provides human-readable descriptions written by the data contributors to enable the identification of the chemical species to a reasonable extent.

Reusable. CKineticsDB provides sufficient provenance which allows researchers to replicate the findings from the associated publication. In this example, the data, metadata, and software are made available under respective licenses. The data and metadata in this example are available under the open-source Creative Commons Attribution 4.0 International Public License, while the software in this example is available under a proprietary license. Sufficient information has been provided to describe the data and the metadata.

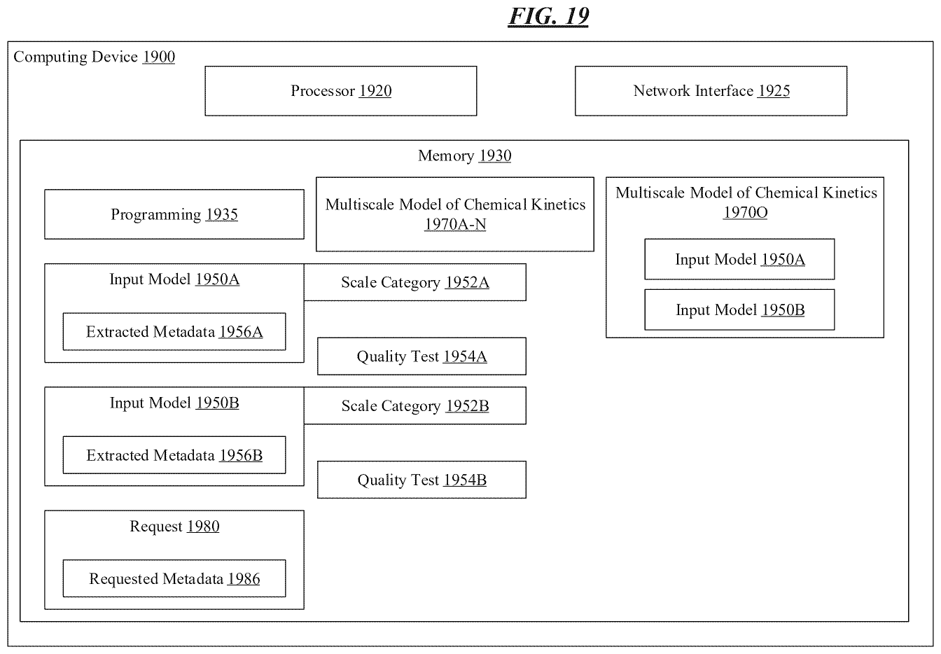

FIG. 19 is a diagram of CKineticsDB implemented on a computing device 1900. In FIGS. 9, CKineticsDB is implemented on a computing cluster 921 with separated servers, and in FIG. 11 CKineticsDB is depicted as a modular software design irrespective of how and where it is installed. However, CKineticsDB can be implemented on a computing device 1900, which may be singular or may be distributed. The computing device 1900 is configured to store one or more multiscale models of chemical kinetics 1970A-N, as it implements CKineticsDB, and includes a processor 1920, a memory 1930, and programming 1935 in the memory 1930. Execution of the programming 1935 by the processor 1920 configures the computing device 1900 to implement functions. The computing device 1900 receives an input model 1950A of chemical kinetics. The computing device 1900 categorizes the input model 1950A with a scale category 1952A e.g., electronic structure calculations input and output, statistical mechanics input and thermochemistry output, or MKM input data. The computing device 1900 tests the input model 1950A based on a quality test 1954A e.g., the quality tests of Table 1 and the metrics and assessment for quality tests of Table 2. The computing device 1900 extracts metadata 1956A from the input model 1950A e.g., the metadata parameters identified in Table 4. The computing device 1900 can also extract metadata 1956A from a file (e.g., a readMe.xlsx file) accompanying the input model 1950A. The computing device 1900 stores the input model 1950A based on the scale category 1952A and the results of the quality test 1954A in the database 902, 1052 as one of the multiscale models of chemical kinetics 1970A-N. The computing device 1900 receives a request 1980 for the one or more multiscale models of chemical kinetics 1970A-N, including one or more requested metadata 1986 e.g., the metadata parameters in Table 4. The computing device 1900 transmits the input model 1950A or a portion thereof in response to the request 1980, based on a match between the one or more requested metadata 1986 and the extracted metadata 1956A. The request 1980 is formed by first presenting the available metadata to a user via a user interface 901, 1051. Then, the user makes selections in the metadata via that user interface 951, 1051, resulting in the selected metadata being the requested metadata 1986. Next, the multiscale models' data in the form of the input model 1950A is downloaded based on a match between the selected requested metadata 1986 and the extracted metadata 1956A, which is associated with the input model 1950A that will be downloaded.

The scale category 1952A can be selected from a group of scale categories, the group of scale categories including: an electronic structure calculation category (electronic structure calculations input and output), multiscale modeling thermochemistry category (statistical mechanics input and thermochemistry output), or a microkinetic modeling category (MKM input data).

The input model 1950A can be stored in an original format, meaning that the format such as a BSON or JSON file may be different than the received input model 1950A format, and may be a format that does not readily conform without conversion to other input model 1950A storage systems.

Testing the input model 1950A based on a quality test 1954A can further comprise identifying a DFT calculation type associated with the input model 1950A, running the quality test 1954A based on a correspondence to the input model 1950A and the identified calculation type, and reporting an assessment of a result from the quality test 1954A (See FIG. 13).

The one or more multiscale models of chemical kinetics 1970A-N comprises multiscale models of heterogenous catalysis, and the input model 1950A of chemical kinetics comprises a model of heterogenous catalysis, preferably a multiscale model of heterogenous catalysis.

In another example, the computing device 1900 is configured to store one or more multiscale models of chemical kinetics 1970A-N, as it implements CKineticsDB, and includes a processor 1920, a memory 1930, and programming 1935 in the memory 1930. Execution of the programming 1935 by the processor 1920 configures the computing device 1900 to implement functions. The computing device 1900 receives a first input model 1950A of chemical kinetics. The computing device 1900 categorizes the first input model 1950A with a first scale category 1952A. The computing device 1900 tests the first input model 1950A based on the administration of a first quality test 1954A. The computing device 1900 extracts first metadata 1956A from the first input model 1950A. The computing device 1900 stores the first input model 1950A based on the first scale category 1952A and the results of the first quality test 1954A in the database 902 as one of the multiscale models of chemical kinetics 1970A-N.

The computing device 1900 receives a second input model 1950B of chemical kinetics. The computing device 1900 categorizes the second input model 1950B with a second scale category 1952B. The computing device 1900 tests the second input model 1950B based on the administration of a second quality test 1954B, which may be the same quality test as the first quality test 1954A. The computing device 1900 extracts second metadata 1956B from the second input model 1950B. The computing device 1900 stores the second input model 1950B based on the second scale category 1952B and the results of the second quality test 1954B in the database 902 as one of the multiscale models of chemical kinetics 1970A-N.

The computing device 1900 receives a request 1980 for the one or more multiscale models of chemical kinetics 1970A-N, including one or more requested metadata 1986. The computing device 1900 transmits the first input model 1950A or a portion thereof and the second input model 1950B or a portion thereof in response to the request 1980, based on a match between the one or more requested metadata 1986 and the extracted first metadata 1956A and the extracted second metadata 1956B.

The first scale category 1952A and the second scale category 1952B can be selected from a group of scale categories, the group of scale categories including: an electronic structure calculation category (electronic structure calculations input and output), multiscale modeling thermochemistry category (statistical mechanics input and thermochemistry output), or a microkinetic modeling category (MKM input data). The first scale category 1952A can be different from the second scale category 1952B.

The first input model 1950A and the second input model 1950B in response to the request 1980 can be transmitted as a combined multiscale model of chemical kinetics 19700. Combining data from different sources and scales into one multiscale model requires an assurance of chemical compatibility. Users can download data from multiple sources which might be across different scales
the one or more multiscale models of chemical kinetics 1970A-O can be multiscale models of heterogenous catalysis. The first input model 1950A of chemical kinetics can be a model of heterogenous catalysis, and the second input model 1950B of chemical kinetics can be a model of heterogenous catalysis.

The computing device 1900 can alternatively be understood as a computer implemented method for storing one or more multiscale models of chemical kinetics 1970A-N, the method comprising using a computer processor 1920, a computer memory 1930, and programming 1935.

The computing device 1900 can still further alternatively be understood as a non-transitory machine-readable medium programmed with machine readable instructions (constituted at least in part by programming 1935) for causing a computer process 1935 to perform storage of one or more multiscale models of chemical kinetics 1970A-N.

The computing device 1900 includes a processor 1920. The processor 1920 serves to perform various operations, for example, in accordance with instructions or programming 1935 executable by the processor 1920. Although the processor 1920 may be configured by use of hardwired logic, typical processors are general processing circuits configured by execution of programming. The processor 1920 includes elements structured and arranged to perform one or more processing functions, typically various data processing functions. Although discrete logic components could be used, the examples utilize components forming a programmable CPU. The processor 1920 for example includes one or more integrated circuit (IC) chips incorporating the electronic elements to perform the functions of the CPU. The processor 1920 for example, may be based on any known or available microprocessor architecture, such as a Reduced Instruction Set Computing (RISC) using an ARM architecture, as commonly used today in mobile devices and other portable electronic devices. Of course, other processor circuitry may be used to form the CPU or processor hardware. Although the illustrated examples of the processor 1920 include only one microprocessor, for convenience, a multi-processor architecture can also be used. A digital signal processor (DSP) or field-programmable gate array (FPGA) could be suitable replacements for the processor 1920 but may consume more power with added complexity. A memory 1930 is coupled to the processor 1920. The memory 1930 is for storing data and programming 1935. In the example, the memory 1930 may include a flash memory (non-volatile or persistent storage) and/or a random-access memory (RAM) (volatile storage). The RAM serves as short term storage for instructions and data being handled by the processor e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

The computing device 1900 may also include a network interface 1925 coupled to the processor 1925. The computing device 1900 may be implemented in a distributed manner: the processor 1900 may be divided in to two or more processors, along with two or more memory 1930 devices. The processors 1920 may work in parallel, and may also specialize and perform particular tasks. The memory 1930 devices may store a full copy of all data, or may specialize and store particular data relevant to a particular processor 1920. In an example, the computing device 1900 is divided into a local and remote grouping. A local processor 1920, local memory 1930, and local network interface 1925 can accept and process chemical kinetic data; while a remote processor 1920, remote memory 1930, and remote network interface 1925 can receive the processed data and perform data warehousing. As used herein, the term “computing device” may refer to distributed and non-distributed systems and may interchangeably be referred to as a computer system, high-performance computing system, or computing cluster. The corresponding functions relating to the devices and systems as described herein may also be articulated as computer-implemented methods to be performed without limitation to any particular type of computer system or computing devices and/or in the form of computer instructions stored in a non-transitory machine-readable medium programmed with instructions stored in the non-transitory machine-readable medium.

Receiving or transmitting data can include digital network communication, electronic signaling, or physical analog communication e.g., fingers typing on a keyboard and eyes receiving information from a digital display.

It should be understood that all of the figures as shown herein depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions or procedures defined in the programs. Various programming languages may be employed to create one or more of the applications, structured in a variety of manners, such as object-oriented programming languages (e.g., Objective-C, Java, or C++), procedural programming languages (e.g., C or assembly language), general-purpose programming languages (e.g., Python), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as +10% from the recited amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected may lie in less than all features of any single disclosed example. Hence, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A computing device configured to store one or more multiscale models of chemical kinetics, the computing device comprising:
a processor;
a memory; and
programming in the memory, wherein execution of the programming by the processor configures the computing device to implement functions, including functions to:
receive an input model of chemical kinetics;
categorize the input model with a scale category;
test the input model based on a quality test;
extract metadata from the input model;
store the input model based on the scale category and results of the quality test;
receive a request for the one or more multiscale models of chemical kinetics, including one or more requested metadata; and
transmit the input model or a portion thereof in response to the request, based on a match between the one or more requested metadata and the extracted metadata.

2. The computing device of claim 1, wherein:
the scale category is selected from a group of scale categories, the group of scale categories including:
i) an electronic structure calculation category;
ii) multiscale modeling thermochemistry category; or
iii) a microkinetic modeling category.

3. The computing device of claim 1, wherein the input model is stored in an original format.

4. The computing device of claim 1, wherein testing the input model based on a quality test further comprises:
identifying a calculation type associated with the input model;
running the quality test based on a correspondence to the input model and the identified calculation type; and
reporting an assessment of a result from the quality test.

5. The computing device of claim 1, wherein:
the one or more multiscale models of chemical kinetics comprise multiscale models of heterogenous catalysis; and
the input model of chemical kinetics comprises a model of heterogenous catalysis.

6. A computing device configured to store one or more multiscale models of chemical kinetics, the computing device comprising:
a processor;
a memory; and
programming in the memory, wherein execution of the programming by the processor configures the computing device to implement functions, including functions to:
receive a first input model of chemical kinetics;
categorize the first input model with a first scale category;
test the first input model based on a first quality test;
extract first metadata from the first input model;
store the first input model based on the first scale category and results of the first quality test;
receive a second input model of chemical kinetics;
categorize the second input model with a second scale category;
test the second input model based on a second quality test;
extract second metadata from the second input model;
store the second input model based on the second scale category and results of the second quality test;
receive a request for the one or more multiscale models of chemical kinetics or a portion thereof, including one or more requested metadata; and
transmit the first input model or a portion thereof and the second input model or a portion thereof in response to the request, based on a match between the one or more requested metadata and the extracted first metadata and the extracted second metadata.

7. The computing device of claim 6, wherein:
the first scale category and the second scale category are selected from a group of scale categories, the group of scale categories including:
i) an electronic structure calculation category;
ii) multiscale modeling thermochemistry category; or
iii) a microkinetic modeling category; and
the first scale category is a different scale category from the second scale category.

8. The computing device of claim 6, wherein the first input model and the second input model in response to the request are transmitted as a combined multiscale model of chemical kinetics.

9. The computing device of claim 6, wherein:
the one or more multiscale models of chemical kinetics are multiscale models of heterogenous catalysis;
the first input model of chemical kinetics is a model of heterogenous catalysis; and
the second input model of chemical kinetics is a model of heterogenous catalysis.

10. A computer implemented method for storing one or more multiscale models of chemical kinetics, the method comprising using a computer processor, a computer memory; and programming in the computer memory configured to cause the processor to perform the steps of:
a) receiving an input model of chemical kinetics;
b) categorizing the input model with a scale category;
c) testing the input model based on a quality test;
d) extracting metadata from the input model;
e) storing the input model based on the scale category and results of the quality test;
f) receiving a request for the one or more multiscale models of chemical kinetics, including one or more requested metadata; and
g) transmitting the input model or a portion thereof in response to the request, based on a match between the one or more requested metadata and the extracted metadata.

11. (canceled)

12. A non-transitory machine-readable medium programmed with machine readable instructions for causing a computer processor to perform the steps of the computer implemented method of claim 10.

13. (canceled)
